(19) United States
(12) Patent Application Publication
(10) Pub. No.: US 2017/0212391 A1
(43) Pub. Date: Jul. 27, 2017

(54) MULTI-DOMAIN VERTICAL ALIGNMENT DISPLAY PANEL AND PIXEL STRUCTURE

(71) Applicant: WUHAN CHINA STAR OPTOELECTRONICS TECHNOLOGY CO., LTD., Wuhan, Hubei (CN)

(72) Inventors: Xin ZHANG, Wuhan, Hubei (CN); Yong ZHAO, Wuhan, Hubei (CN); Bingder LIU, Wuhan, Hubei (CN)

(21) Appl. No.: 15/030,609

(22) PCT Filed: Feb. 26, 2016
(86) PCT No.: PCT/CN2016/074678

§ 371 Date: Apr. 20, 2016

(30) Foreign Application Priority Data
Jan. 21, 2016 (CN) 201610040197.0

(51) Int. Cl. G02F 1/1337; G02F 1/1368

(52) U.S. Cl. CPC G02F 1/133753; G02F 1/1368; G02F 2001/133391

(57) ABSTRACT

A multi-domain vertical alignment display panel and a pixel structure are provided. The pixel structure includes three subpixels arranged in a row, wherein the three subpixels respectively consist of an upper alignment region and a lower alignment region. The upper alignment region and lower alignment region respectively includes four, subregions, and alignment directions of the upper and lower adjacent subregions as well as the left and right subregions are perpendicular to each other. Alignment directions of any two adjacent subregions respectively located in the upper and lower adjacent subpixels as well as the left and right adjacent subpixels are identical. The alignment directions of any two adjacent subregions respectively located in the vertically adjacent upper alignment region and lower alignment region are identical, so as to reduce dark lines and increase light transmittance.

### BACKGROUND OF THE INVENTION

Field of Invention

The present invention relates to a display panel and pixel structure, and in particular to an UV-induced multi-domain vertical alignment display panel and pixel structure.

Description of Prior Art

A thin-film transistor liquid crystal display (TFT-LCD) has been rapidly developed and widely applied in recent years. Specifically, the TFT-LCD can be regarded as two glass substrate and a liquid crystal layer being sandwiched therebetween. The upper glass substrate is, a color filter, and the lower glass substrate glass substrate is provided with thin-film transistors thereon. When a current passes through the thin film transistor, an electric field changes. The change of the electric field causes a twist of the liquid crystal molecules, thereby changing polarization of light to achieve the desired image display. Before a voltage is applied, the liquid crystal molecules need to have an initial orientation. Thus, the display panel is usually provided with an alignment film, which controls arranging directions and angles of the liquid crystal molecules.

With the progress of the alignment technology, a photo-alignment technology is gradually replacing the traditional way of a rubbing alignment technology. In order to reduce a color shift at a large viewing angle, a single pixel is generally made of multi-domain displays, such that different domains of the liquid crystal molecules have different pretilt angles. The role of a photo-alignment film is to replace traditional protrusion or slit structures, thereby avoiding the light leakage caused from the traditional protrusion and slit structures to greatly enhance an aperture ratio, and to make the liquid crystal molecules in subpixel regions have an initial pretilt angle for speeding up a response time.

As shown in FIG. 1, a pixel 10 includes red, green, and blue subpixels R, G, and B. Each subpixel is divided into a main alignment region 12 and a main alignment region 14, and the main alignment region 12 and the minor alignment region 14 are further divided into four equal-sized subregions. Moreover, alignment directions of the two adjacent subregions in the same subpixel are different, thereby achieving the needs of the wide viewing angle. However, as shown in FIG. 2, while displaying images, since twist directions of the liquid crystal molecules are different, the boundaries between the main alignment region 12 and the minor alignment region 14 and the boundaries between the subregions will appear dark line such that the main alignment region 12 and the minor alignment region have “swastika” dark lines, which influences light transmittance.

### SUMMARY OF THE INVENTION

An objective of the present invention is to provide a multi-domain vertical alignment (MVA) display panel to reduce the dark lines, thereby improving the light transmittance by configuring the alignment directions of the subregions.

Another objective of the present invention is to provide a MVA pixel structure to reduce the dark lines, thereby improving the light transmittance by configuring the alignment directions of the subregions.

To achieve the foregoing objective, a preferred embodiment of the present invention provides a MVA display panel, which includes a plurality of pixel units arranged in a matrix, each pixel unit comprising three subpixels arranged in a row, wherein the three subpixels respectively consist of an upper alignment region and a lower alignment region; the upper alignment region and lower alignment region respectively comprising four subregions, alignment directions of the upper and lower adjacent subregions as well as the left and right subregions being perpendicular to each other; alignment directions of any two adjacent subregions respectively located in the upper and lower adjacent subpixels as well as the left and right adjacent subpixels being identical; and alignment directions of any two adjacent subregions respectively located in the vertically adjacent upper alignment region and lower alignment region being identical.

In the display panel of the preferred embodiment of the present invention, areas of the tour subregions of the upper alignment region are identical, and the four subregions thereof are arranged in a 2×2 matrix; areas of the four subregions of the lower alignment region are identical, and the four subregions thereof are arranged in a 2×2 matrix.

In the display panel of the preferred embodiment of the present invention, an angle between the alignment directions and a horizontal direction is 45°, 135°, −45°, or −135°.

In the display panel of the preferred embodiment of the present invention, the display panel further comprises a first substrate and a second substrate opposite to each other, the first substrate comprising a first photo-alignment film, and the second substrate comprising a second photo-alignment film, alignment directions of the first photo-alignment film being perpendicular to alignment directions of the second photo-alignment film.

In the display panel of the preferred embodiment of the present invention, the alignment directions of the first photo-alignment film are vertical directions, and the alignment directions of the second photo-alignment film are horizontal directions. Specifically, the first photo-alignment film comprises two alignment directions corresponding to each subpixel, and the two alignment directions are parallel and reverse to each other; the second photo-alignment film comprises two alignment directions corresponding to each of the upper alignment region and the lower alignment region, and the two alignment directions are parallel and reverse to each other. Furthermore, two adjacent alignment directions of the first photo-alignment film corresponding to the left and right adjacent subpixels are identical two adjacent alignment directions of the second photo-alignment film corresponding to the vertically adjacent upper alignment region and lower alignment region are identical.

Similarly, in order to achieve the foregoing objective, another preferred embodiment of the present invention provides a MVA pixel structure, which includes three subpixels arranged in a row, wherein the three subpixels respectively consist of an upper alignment region and a lower alignment region; the upper alignment region and lower alignment region respectively comprising four subregions, alignment directions of the upper and lower adjacent subregions as well as the left and right subregions being perpendicular to each other; alignment directions of any two adjacent subregions respectively located in the upper and lower adjacent subpixels as well as the left and right adjacent subpixels being identical; and alignment directions of any two adjacent subregions respectively located in the vertically adjacent upper alignment region and lower alignment region being identical.

In the pixel structure of the preferred embodiment of the present invention, areas of the four subregions of the upper alignment region are identical, and the four subregions thereof are arranged in a 2×2 matrix; areas of the four subregions of the lower alignment region are identical, and the four subregions thereof are arranged in a 2×2 matrix.

In the pixel structure of the preferred embodiment of the present invention, an angle between the alignment directions and a horizontal direction is 45°, 135°, −45°, or −135°.

In comparison with the prior art, the present invention is capable of reducing the dark lines between the upper and lower as well as left and right adjacent subpixels by configuring the alignment directions of any two adjacent subregions respectively located in the upper and lower adjacent subpixels as well as the left and right adjacent subpixels to be identical. In addition, the alignment directions of any two adjacent subregions respectively located in the upper alignment region and the lower alignment region are configured to be identical. That is, fifty percent of the dark lines altogether can be reduced, thereby improving the light transmittance.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a schematic drawing illustrating alignment of a prior art pixel;

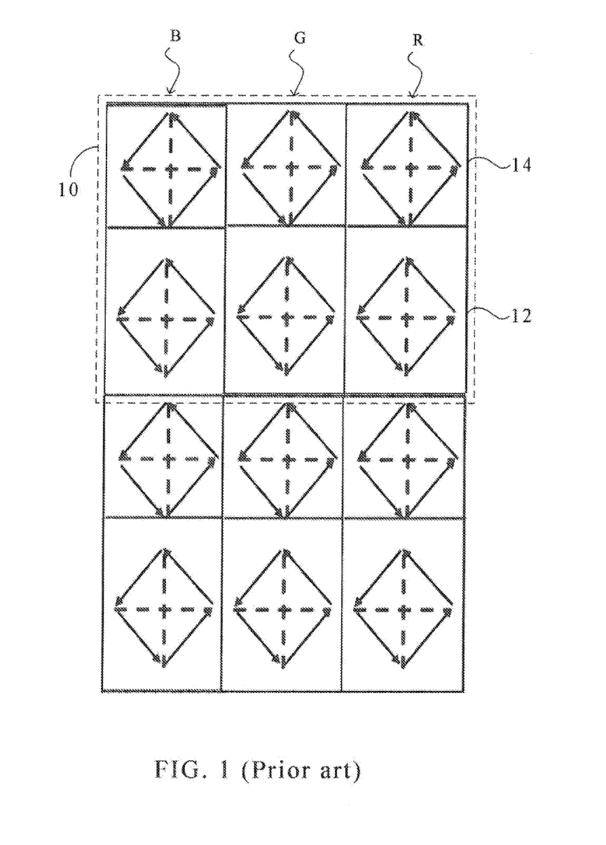

FIG. 2 is a schematic drawing illustrating the prior art pixel displaying images;

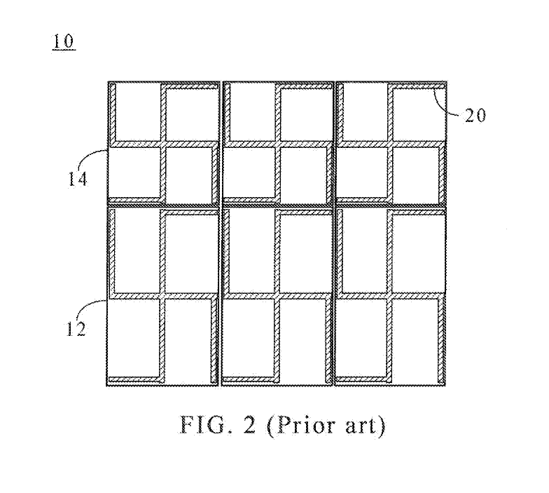

FIG. 3 is a schematic drawing illustrating a MVA display panel according to a preferred embodiment of the present invention;

FIG. 4 is a top view schematically illustrating a first substrate according to the preferred embodiment of the present invention;

FIG. 5 is a top view schematically illustrating a second substrate according to the preferred embodiment of the present invention; and

FIG. 6 is a schematic drawing illustrating the display of the MVA pixel unit of the embodiment.

### DETAILED DESCRIPTION OF THE PREFERRED EMBODIMENTS

Descriptions of the following embodiments refer to attached drawings which are utilized to exemplify specific embodiments. Directional terms mentioned in the present invention, such as “top” and “down”, “front”, “rear”, “left”, “right”, “inside”, “outside”, “side” and so on are only directions with respect to the attached drawings. Therefore, the used directional terms are utilized to explain and understand the present invention but not to limit the present invention.

In different drawings, the same reference numerals refer to like parts throughout the drawings.

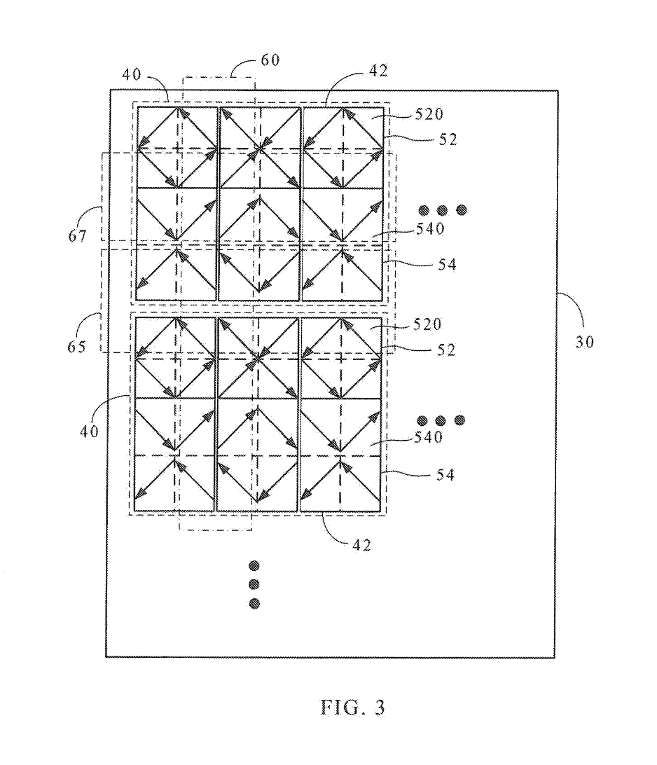

Referring to FIG. 3, FIG. 3 is a schematic drawing illustrating a MVA display panel according to one preferred embodiment of the present invention. The MVA display panel 30 of the preferred embodiment of the present invention includes a plurality of pixel units arranged in a matrix 40. In order to explain clearly, the drawing only shows two pixel units 40. Each pixel unit 40 includes three subpixels 42 arranged in a row. Specifically, the three subpixels 42 are red, green, and blue subpixels respectively. The three subpixels 42 respectively consist of an upper alignment region 52 and a lower alignment region 54.

As shown in FIG. 3, the upper alignment region 52 and the lower alignment region 54 respectively include four subregions 520 and 540. In the embodiment, areas of the four subregions 520 of the upper alignment region 52 are identical, and the four subregions 520 thereof are arranged in a 2×2 matrix. Similarly, areas of the four subregions 540 of the lower alignment region 54 are identical, and the four subregions 540 thereof are arranged in a 2×2 matrix.

Furthermore, the alignment directions (as shown in arrows) of the upper and lower as well as left and right adjacent subregions 520 and 540 in the four subregions 520 and 540 of the upper alignment region 52 and the lower alignment region 54 are perpendicular to each other. Specifically, the angle between the alignment directions and a horizontal direction is 45°, 135°, −45°, or −135°. In addition, in order to reduce the dark lines, the alignment directions of any two adjacent subregions 520 and 540 respectively located in the upper and lower as well as left and right adjacent subpixels 42 are identical, as shown in indicating boxes 60 and 65. Moreover, the alignment directions of any two adjacent subregions 520 and 540 respectively located in the vertically adjacent upper alignment region 52 and lower alignment region 54 are identical, as shown in an indicating box 67. Since the alignment directions of the two adjacent subregions 520 and 540 as shown are the same, the problem of the alignment mismatch between any two adjacent subregions 520 and 540, whereby the dark lines do not appear.

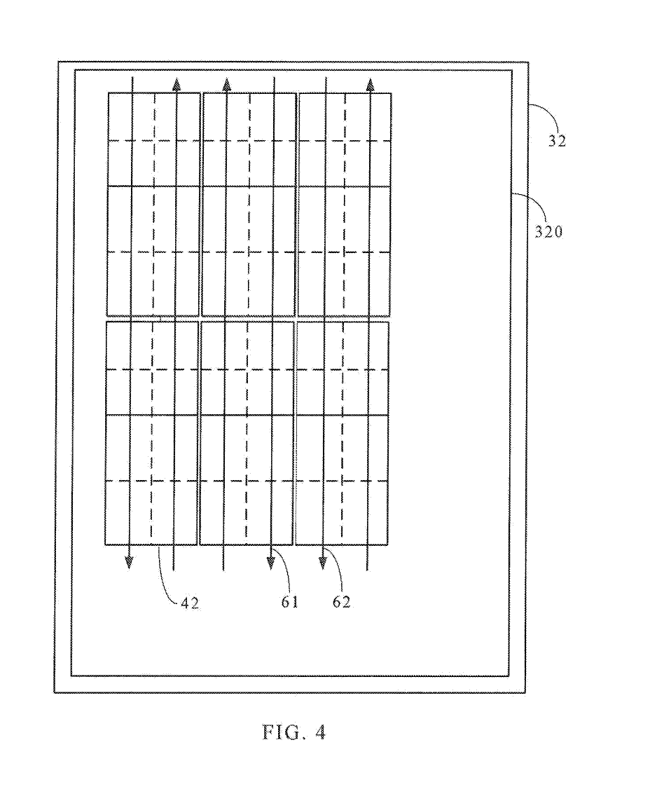

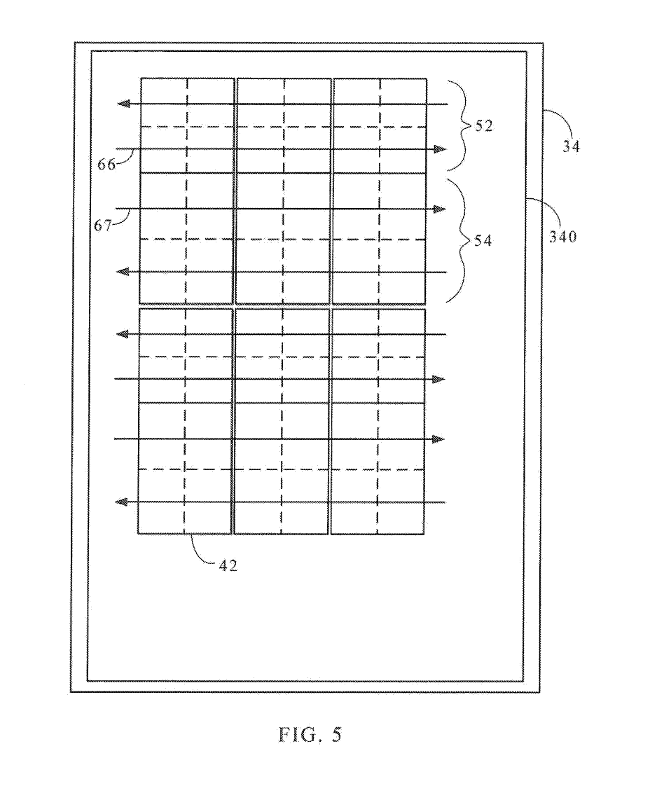

Referring to FIG. 4 and FIG. 5, FIG, 4 is a top view schematically illustrating a first substrate according to the preferred embodiment of the present invention; FIG. 5 is a top view schematically illustrating a second substrate according to the preferred embodiment of the present invention. The display panel 30 of the embodiment further includes a first substrate 32 and a second substrate 34 opposite to each other. For example, the first substrate is an array substrate, and the second substrate 34 is a color filter (CF) substrate. The first substrate 32 includes a first photo-alignment film 320, and the second substrate 34 includes a second photo-alignment film 340. The alignment directions (as shown in arrows) of the first photo-alignment film are perpendicular to the alignment directions (as shown in arrows) of the second photo-alignment film.

In the embodiment, the alignment directions of the first photo-alignment film 320 are vertical, and the alignment directions of the second photo-alignment film 340 are horizontal. Furthermore, the first photo-alignment film 320 includes two alignment directions corresponding to each subpixel 42, and the two alignment directions are parallel and reverse to each other. The second photo-alignment film 340 includes two alignment directions corresponding to each of the upper alignment region 52 and the lower alignment region 54, and the two alignment directions are parallel and reverse to each other. Furthermore, as shown in FIG. 4, the two adjacent alignment directions of the first photo-alignment film 320 corresponding to the left and right adjacent subpixels 42 are identical, as shown in alignment directions 61 and 62. As shown in FIG. 5, the two adjacent alignment directions of the second photo-alignment film 340 corresponding to the vertically adjacent upper alignment region 52 and lower alignment region 54 are identical, as shown in alignment directions 66 and 67.

As shown in FIG. 3, after assembling the first substrate 32 and the second substrate 34, the alignment direction of each subregion 520 or 540 is a synthesis result of the respective alignment directions of said first substrate 32 and second substrate 34.

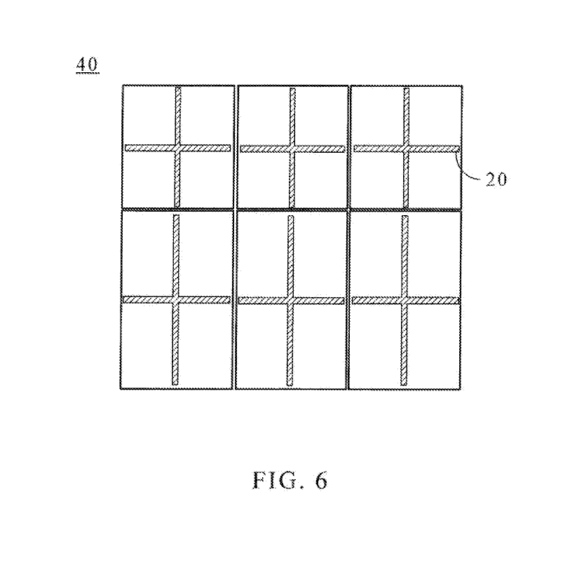

Referring to FIG. 6, FIG. 6 is a schematic drawing illustrating the display of the MVA pixel unit of the embodiment. When the pixel unit 40 of the embodiment displays images, since the alignment directions of any two adjacent subregions 520 and 540 respectively located in the upper and lower as well as left and right adjacent subpixels 42 are identical, and the alignment directions of any two adjacent subregions 520 and 540 respectively located in the vertically adjacent upper alignment region 52 and lower alignment region 54 are identical, the dark lines between the upper and lower as well as left and right adjacent subpixels 42 will disappear, and the dark lines between the upper alignment region 52 and the lower alignment region 54 will also disappear, so as to increase the light transmittance. It can be seen from the foregoing that the present invention is capable of reducing the dark lines between the upper and lower as well as left and right adjacent subpixels 42. That is, fifty percent of the dark lines altogether can be reduced, thereby improving the light transmittance.

The following will explain the MVA pixel structure of the preferred embodiment of the present invention. Referring to the pixel unit 40 of FIG. 3, the pixel structure of the embodiment includes three subpixels 42 arranged in a row. The three subpixels 42 respectively consist of an upper alignment region 52 and a lower alignment region 54. The upper alignment region 52 and the lower alignment region 54 respectively include four subregions 520 and 540.

In the embodiment, the areas of the four subregions 520 of the upper alignment region 52 are identical, and the four subregions 520 thereof are arranged in a 2×2 matrix. Similarly, the areas of the four subregions 540 of the lower alignment region 54 are identical, and the four subregions 540 thereof are arranged in a 2×2 matrix.

Furthermore, the alignment directions (as shown in arrows) of the upper and lower as well as left and right adjacent subregions 520 and 540 in the four subregions 520 and 540 of the upper alignment region 52 and the lower alignment region 54 are perpendicular to each other. Specifically, an angle between the alignment directions and a horizontal direction is 45°, 135°, −45°, or −135°. In order to reduce the dark lines, the alignment directions of any two adjacent subregions 520 and 540 respectively located in the upper and lower as well as left and right adjacent subpixels 42 are identical, as shown in indicating boxes 60 and 65. Moreover, the alignment directions of any two adjacent subregions 520 and 540 respectively located in the vertically adjacent upper alignment region 52 and lower alignment region 54 are identical, as shown in an indicating box 67. Since the alignment directions of the two adjacent subregions 520 and 540 as shown are the same, the problem of the alignment mismatch between any two adjacent subregions 520 and 540, whereby the dark lines do not appear.

In summary, the present invention is capable of reducing the dark lines between the upper and lower as well as left and right adjacent subpixels 42 by configuring the alignment directions of any two adjacent subregions 520 and 540 respectively located in the upper and lower adjacent subpixels 42 as well as the left and right adjacent subpixels 42 to be identical. In addition, the alignment directions of any two adjacent subregions 520 and 540 respectively located in the vertically adjacent upper alignment region 52 and lower alignment region 54 are configured to be identical, thereby reducing the dark lines between the upper alignment region 52 and the lower alignment region 54. That is, fifty percent of the dark lines altogether can be reduced, thereby improving the light transmittance.

While the preferred embodiments of the present invention have been illustrated and, described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A multi-domain vertical alignment display panel, comprising a plurality of pixel units arranged in a matrix, each pixel unit comprising three subpixels arranged in a row, wherein the three subpixels respectively consist of an upper alignment region and a lower alignment region; the upper alignment region and lower alignment region respectively comprising four subregions, alignment directions of the upper and lower adjacent subregions as well as the left and right subregions being perpendicular to each other; alignment directions of any two adjacent subregions respectively located in the upper and lower adjacent subpixels as well as the left and right adjacent subpixels being identical; and alignment directions of any two adjacent subregions respectively located in the vertically adjacent upper alignment region and lower alignment region being identical.

2. The multi-domain vertical alignment display panel according to claim 1, wherein areas of the four subregions of the upper alignment region are identical, and the four subregions thereof are arranged in a 2×2 matrix; areas of the four subregions of the lower alignment region are identical, and the four subregions thereof are arranged in a 2×2 matrix.

3. The multi-domain vertical alignment display panel according to claim 1, wherein an angle between the alignment directions and a horizontal direction is 45°, 135°, −45°, or −135°.

4. The multi-domain vertical alignment display panel according to claim 1, wherein the display panel further comprises a first substrate and a second substrate opposite to each other, the first substrate comprising a first photo-alignment film, and the second substrate comprising a second photo-alignment film, alignment directions of the first photo-alignment film being perpendicular to alignment directions of the second photo-alignment film.

5. The multi-domain vertical alignment display panel according to claim 4, wherein the alignment directions of the first photo-alignment film are vertical directions, and the alignment directions of the second photo-alignment film are horizontal directions.

6. The multi-domain vertical alignment display panel according to claim 5, wherein the first photo-alignment film comprises two alignment directions corresponding to each subpixel, and the two alignment directions are parallel and reverse to each other; the second photo-alignment film comprises two alignment directions corresponding to each of the upper alignment region and the lower alignment region, and the two alignment directions are parallel and reverse to each other.

7. The multi-domain vertical alignment display panel according to claim 6, wherein two adjacent alignment directions of the first photo-alignment film corresponding to the left and right adjacent subpixels are identical; two adjacent alignment directions of the second photo-alignment film corresponding to the vertically adjacent upper alignment region and lower alignment region are identical.

8. A multi-domain vertical alignment pixel structure, comprising three subpixels arranged in a row, wherein the three subpixels respectively consist of an upper alignment region and a lower alignment region; the upper alignment region and lower alignment region respectively comprising four subregions, alignment directions of the upper and lower adjacent subregions as well as the left and right subregions being perpendicular to each other; alignment directions of any two adjacent subregions respectively located in the upper and lower adjacent subpixels as well as the left and right adjacent subpixels being identical; and alignment directions of any two adjacent subregions respectively located in the vertically adjacent upper alignment region and lower alignment region being identical.

9. The multi-domain vertical alignment pixel structure according to claim 8, wherein areas of the four subregions of the upper alignment region are identical, and the four subregions thereof are arranged in a 2×2 matrix; areas of the four subregions of the lower alignment region are identical, and the four subregions thereof are arranged in a 2×2 matrix.

10. The multi-domain vertical alignment pixel structure according to claim 8, wherein an angle between the alignment directions and a horizontal direction is 45°, 135°, −45°, or −135°.

11. The multi-domain vertical alignment pixel structure according to claim 8, wherein the pixel structure further comprises a first substrate and a second substrate opposite to each other, the first substrate comprising a first photo-alignment film, and the second substrate comprising a second photo-alignment film, alignment directions of the first photo-alignment film being perpendicular to alignment directions of the second photo-alignment film.

12. The multi-domain vertical alignment pixel structure according to claim 11, wherein the alignment directions of the first photo-alignment film are vertical directions, and the alignment directions of the second photo-alignment film, are horizontal directions.

13. The multi-domain vertical alignment pixel structure according to claim 12, wherein the first photo-alignment film comprises two alignment directions corresponding to each subpixel, and the two alignment directions are parallel and reverse to each other; the second photo-alignment film comprises two alignment directions corresponding to each of the upper alignment region and the lower alignment region, and the two alignment directions are parallel and reverse to each other.

14. The multi-domain vertical alignment pixel structure according to claim 13, wherein two adjacent alignment directions of the first photo-alignment film corresponding to the left and right adjacent subpixels are identical; two adjacent alignment directions of the second photo-alignment film corresponding to the vertically adjacent upper alignment region and lower alignment region are identical.
